(19) United States
(12) Patent Application Publication
(10) Pub. No.: US 2022/0166448 A1
(43) Pub. Date: May 26, 2022

(54) COMMUNICATION DEVICE

(71) Applicant: Sony Group Corporation, Tokyo (JP)

(72) Inventor: Shunsuke NAKAI, Tokyo (JP)

(73) Assignee: Sony Group Corporation, Tokyo (JP)

(21) Appl. No.: 17/602,302

(22) PCT Filed: May 17, 2019
(86) PCT No.: PCT/JP2019/019812

§ 371 Date: Oct. 8, 2021

(51) Int. Cl. H04B 1/00; H01Q 1/52; H01Q 1/24

(52) U.S. Cl. CPC H04B 1/0064; H01Q 1/243; H01Q 1/521

(57) ABSTRACT

A communication device according to the present disclosure includes a housing and at least one antenna component. The housing includes at least one metal portion used as an antenna that performs wireless communication in a first frequency band, and a transmission portion fixed to the metal portion and capable of transmitting radio waves. The metal portion is located at least at an end portion of the housing in a first direction. The antenna component is used for wireless communication in a second frequency band, and is covered with the transmission portion.

### FIELD

The present disclosure relates to a communication device.

### BACKGROUND

A communication device capable of performing wireless communication in a plurality of frequency bands (multi-band) by including a plurality of antennas is known. Radio waves used for wireless communication may have different properties depending on the frequency.

### CITATION LIST

### Patent Literature

Patent Literature 1: JP 2007-123982 A

### SUMMARY

### Technical Problem

Depending on the use mode of the communication device, there is a possibility that communication performance in wireless communication in at least one of the plurality of frequency bands is deteriorated. For example, in a case where the communication device is held by a hand of a user, communication performance of the communication device may be deteriorated by the hand of the user.

Therefore, the present disclosure proposes a communication device capable of suppressing deterioration of communication performance in wireless communication in a plurality of frequency bands.

### Solution to Problem

A communication device according to the present disclosure includes a housing and at least one antenna component. The housing includes at least one metal portion used as an antenna that performs wireless communication in a first frequency band, and a transmission portion fixed to the metal portion and capable of transmitting radio waves. The metal portion is located at least at an end portion of the housing in a first direction. The antenna component is used for wireless communication in a second frequency band, and is covered with the transmission portion.

### BRIEF DESCRIPTION OF DRAWINGS

FIG. 1 is a perspective view schematically illustrating a communication device according to a first embodiment of the present disclosure.

FIG. 2 is a front view schematically illustrating a part of an internal configuration of the communication device according to the first embodiment of the present disclosure.

FIG. 3 is a front view partially and schematically illustrating a part of the internal configuration of the communication device according to the first embodiment of the present disclosure.

FIG. 4 is a front view partially and schematically illustrating a part of an internal configuration of a communication device according to a second embodiment of the present disclosure.

FIG. 5 is a front view schematically illustrating a part of an internal configuration of a communication device according to a third embodiment of the present disclosure.

FIG. 6 is a front view partially and schematically illustrating a part of an internal configuration of a communication device according to a fourth embodiment of the present disclosure.

FIG. 7 is a front view schematically illustrating a part of an internal configuration of a communication device according to a fifth embodiment of the present disclosure.

FIG. 8 is a front view schematically illustrating a part of an internal configuration of a communication device according to a modification of the fifth embodiment of the present disclosure.

### DESCRIPTION OF EMBODIMENTS

Hereinafter, embodiments of the present disclosure will be described in detail with reference to the drawings. Note that in each of the following embodiments, the same parts are denoted by the same reference numerals, and redundant description will be omitted.

### First Embodiment

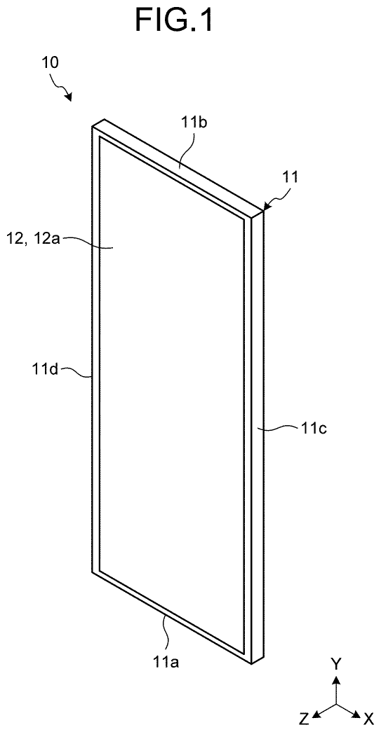

FIG. 1 is a perspective view schematically illustrating a communication device 10 according to a first embodiment. As illustrated in FIG. 1, an example of the communication device 10 is a smartphone. Note that the communication device 10 may be, for example, a personal computer, a portable computer, a tablet, a personal digital assistant (PDA), a game machine, a smartwatch, a wearable device, an Internet of Things (IoT) device, or another device that performs communication.

As illustrated in the drawings, in the present specification, an X axis, a Y axis, and a Z axis are defined for convenience. The X axis, the Y axis, and the Z axis are orthogonal to each other. The X axis is provided along a width of the communication device 10. The Y axis is provided along a length of the communication device 10. The Z axis is provided along a thickness of the communication device 10.

Furthermore, in the present specification, an X direction, a Y direction, and a Z direction are defined. The X direction is a direction along the X axis and includes a +X direction indicated by an arrow of the X axis and a −X direction which is an opposite direction of the arrow of the X axis. The X direction is a short direction of the communication device 10. The Y direction is a direction along the Y axis, and includes a +Y direction indicated by an arrow of the Y axis and a −Y direction which is an opposite direction of the arrow of the Y axis. The Y direction is a longitudinal direction of the communication device 10. The Z direction is a direction along the Z axis and includes a +Z direction indicated by an arrow of the Z axis and a −Z direction which is an opposite direction of the arrow of the Z axis.

Hereinafter, based on FIG. 1, the +X direction may be referred to as a right direction, the −X direction may be referred to as a left direction, the +Y direction may be referred to as an upper direction, the −Y direction may be referred to as a lower direction, the +Z direction may be referred to as a front direction, and the −Z direction may be referred to as a rear direction for convenience. In the present specification, expressions indicating positions and directions such as right, left, upper, lower, front, and rear are defined with reference to the communication device 10 when used in a vertical orientation as illustrated in FIG. 1. Note that the communication device 10 may be used in a direction different from that in FIG. 1. For example, the communication device 10 may be used sideways such that the +X direction is the upper direction, the −X direction is the lower direction, the +Y direction is the left direction, and the −Y direction is the right direction.

The −Y direction and the lower direction are examples of a first direction. The +Y direction and the upper direction are opposite to the −Y direction and the lower direction, and are examples of a second direction and a fourth direction. The +X direction and the right direction are directions orthogonal to (intersecting with) the −Y direction and the lower direction, and are examples of a third direction. The −X direction and the left direction are opposite to the +X direction and the right direction, and are examples of a fifth direction. The third direction may obliquely intersect with the first direction.

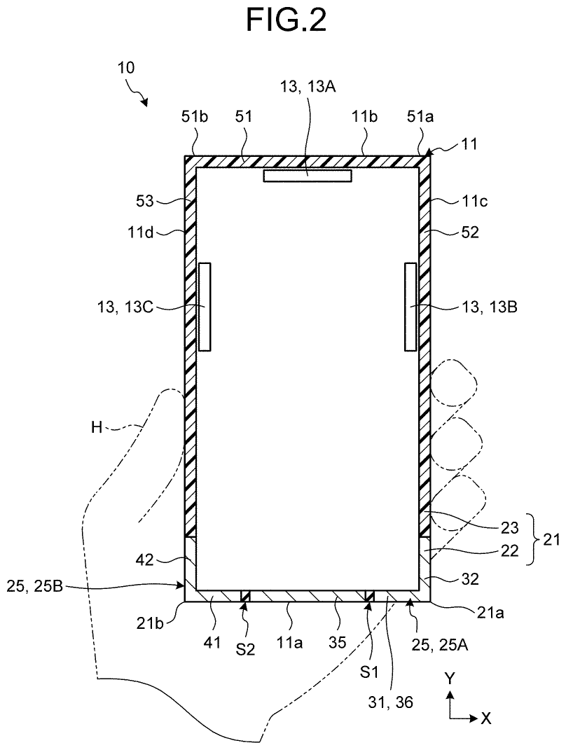

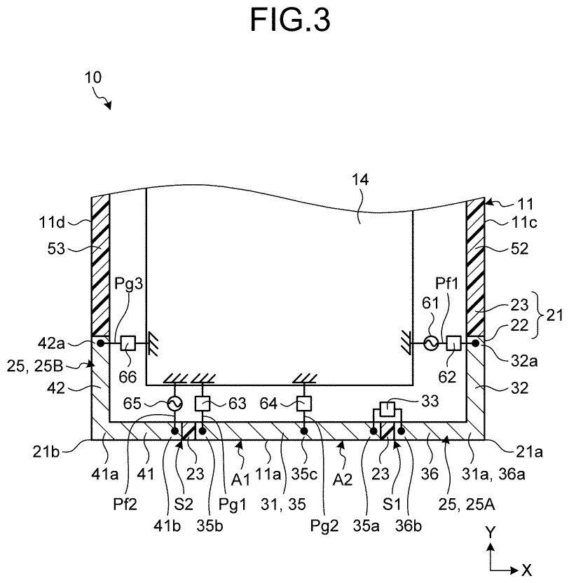

FIG. 2 is a front view schematically illustrating a part of an internal configuration of the communication device 10 of the first embodiment. FIG. 3 is a front view partially and schematically illustrating a part of the internal configuration of the communication device 10 of the first embodiment. As illustrated in FIGS. 1 to 3, the communication device 10 includes a housing 11, a display device 12, a plurality of antenna components 13, and a ground 14.

As illustrated in FIG. 2, the housing 11 includes a frame 21. The frame 21 is formed in a substantially rectangular frame shape elongated in the Y direction. That is, the Y direction is also a longitudinal direction of the frame 21. Note that the frame 21 may be formed in another shape. The display device 12, the antenna components 13, and the ground 14 are accommodated in the housing 11 so as to be disposed inside the frame 21.

The frame 21 has a metal portion 22 and a resin portion 23. The resin portion 23 is an example of a transmission portion. The resin portion 23 may also be referred to as an insulating portion. The frame 21 may have other portions.

The metal portion 22 is made of metal and has conductivity. The metal portion 22 is used as an antenna that performs wireless communication in a predetermined frequency band. The metal portion 22 is located at least at a lower end portion 11a of the housing 11. The lower end portion 11a is an end portion of the housing 11 in the lower direction, and is an example of an end portion of the housing in the first direction. The lower end portion 11a includes an end of the housing 11 facing downward and at least some portions including the end. The lower end portion 11a extends in the X direction orthogonal to (intersecting with) the longitudinal direction of the frame 21.

In the first embodiment, the metal portion 22 has two antenna portions 25. Note that the metal portion 22 may have only one antenna portion 25 or may have three or more antenna portions 25. Hereinafter, the two antenna portions 25 may be individually referred to as antenna portions 25A and 25B. The antenna portion 25A is an example of a first antenna portion. The antenna portion 25B is an example of a second antenna portion. Note that a description common to the antenna portions 25A and 25B will be described as the description of the antenna portions 25.

As illustrated in FIG. 3, the antenna portion 25A includes a lower end wall 31, a right end wall 32, and an electric component 33. The lower end wall 31 is an example of a first end wall. The right end wall 32 is an example of a second end wall.

The lower end wall 31 is located at the lower end portion 11a of the housing 11 and extends in the X direction (+X direction). That is, the lower end wall 31 extends in a direction orthogonal to (intersecting with) a direction in which the lower end portion 11a faces. The lower end wall 31 has a first wall 35 and a second wall 36.

The first wall 35 is located at a substantially central portion of the housing 11 in the X direction. Note the first wall 35 may be located at a position biased in the +X direction or the −X direction in the X direction. The first wall 35 extends in the X direction (+X direction).

The second wall 36 is separated from the first wall 35 in the +X direction. That is, the second wall 36 is separated from the first wall 35 in a direction in which the lower end wall 31 extends. Therefore, a slit S1 is provided between the first wall 35 and the second wall 36. The slit S1 between the first wall 35 and the second wall 36 is filled with the resin portion 23. That is, a part of the resin portion 23 is interposed between the first wall 35 and the second wall 36.

The second wall 36 extends in the X direction (+X direction). That is, the second wall 36 extends in the direction in which the lower end wall 31 extends. The first wall 35, the second wall 36, and the resin portion 23 of the slit S1 form one wall extending substantially linearly in the X direction. Note that the first wall 35, the second wall 36, and the resin portion 23 of the slit S1 may be bent or may be shifted in the Y direction.

The right end wall 32 is connected to a right end portion 36a of the second wall 36 and extends in the +Y direction. That is, the right end wall 32 extends in a direction orthogonal to (intersecting with) the direction in which the lower end wall 31 extends. The right end portion 36a is an end portion of the second wall 36 in the +X direction, and is an example of an end portion of a second wall in the third direction. The right end portion 36a is also an end portion of the second wall 36 on an opposite side of the first wall 35.

The right end portion 36a of the second wall 36 is also a right end portion 31a of the lower end wall 31. The right end portion 31a is an end portion of the lower end wall 31 in the +X direction, and is an example of an end portion of the first end wall in the third direction.

In an example of FIG. 3, the right end wall 32 extends in the +Y direction from the right end portion 36a of the second wall 36. Note that, for example, a substantially arc-shaped portion may be interposed between the right end wall 32 and the right end portion 36a of the second wall 36. A length of the right end wall 32 in the Y direction is shorter than half the length of the housing 11 in the Y direction. Note that the length of the right end wall 32 is not limited to this example.

As described above, the antenna portion 25A is formed into a substantially L shape. The antenna portion 25A forms a corner portion 21a of the frame 21. The corner portion 21a is a portion where the lower end wall 31 and the right end wall 32 are connected.

The electric component 33 is, for example, a filter, an inductor, or a capacitor. Note that the electric component 33 is not limited to this example. The electric component 33 electrically connects a right end portion 35a of the first wall 35 and a left end portion 36b of the second wall 36 of the lower end wall 31. The right end portion 35a is an end portion of the first wall 35 in the +X direction. In addition, the right end portion 35a is one end portion closer to the second wall 36 than another end portion among the end portions of the first wall 35. The left end portion 36b is an end portion of the second wall 36 in the −X direction. In addition, the left end portion 36b is one end portion closer to the first wall 35 than another end portion among the end portions of the second wall 36.

The antenna portion 25B is separated from the antenna portion 25A. The antenna portion 25B has a lower end wall 41 and a left end wall 42. The lower end wall 41 is an example of a third end wall. The left end wall 42 is an example of a fourth end wall.

The lower end wall 41 is located at the lower end portion 11a of the housing 11 and extends in the X direction (−X direction). That is, the lower end wall 41 extends in a same direction (parallel) as the lower end wall 31. The lower end wall 41 is separated in the −X direction from the first wall 35 of the lower end wall 31 of the antenna portion 25A. That is, the lower end wall 41 is separated from the first wall 35 on an opposite side of the second wall 36. Therefore, a slit S2 is provided between the lower end wall 41 and the lower end wall 31 of the antenna portion 25A.

The slit S2 between the lower end wall 31 of the antenna portion 25A and the lower end wall 41 of the antenna portion 25B is filled with the resin portion 23. That is, a part of the resin portion 23 is interposed between the lower end wall 31 of the antenna portion 25A and the lower end wall 41 of the antenna portion 25B.

The lower end wall 31 of the antenna portion 25A, the lower end wall 41 of the antenna portion 25B, the resin portion 23 of the slit S1, and the resin portion 23 of the slit S2 form one wall extending substantially linearly in the X direction. Note that the lower end walls 31 and 41 and the resin portion 23 may be bent or may be shifted in the Y direction.

The left end wall 42 is connected to a left end portion 41a of the lower end wall 41 and extends in the +Y direction. That is, the left end wall 42 extends in a direction orthogonal to (intersecting with) the direction in which the lower end wall 31 extends. The left end portion 41a is an end portion of the lower end wall 41 in the −X direction, and is an example of an end portion of the third end wall in the fourth direction. The left end portion 41a is also an end portion of the lower end wall 41 on an opposite side of the first wall 35.

In the example of FIG. 3, the left end wall 42 extends in the +Y direction from the left end portion 41a of the lower end wall 41. Note that a substantially arc-shaped portion may be interposed between the left end wall 42 and the left end portion 41a of the lower end wall 41. A length of the left end wall 42 in the Y direction is shorter than half the length of the housing 11 in the Y direction. Note that the length of the left end wall 42 is not limited to this example.

As described above, the antenna portion 25B is formed into a substantially L shape. The antenna portion 25B forms a corner portion 21b of the frame 21. The corner portion 21b is a portion where the lower end wall 41 and the left end wall 42 are connected.

The antenna portions 25A and 25B are used as different antennas. In the present disclosure, a length of the antenna portion 25A as an antenna is different from a length of the antenna portion 25B as an antenna. The lengths as antennas are, for example, lengths at which electricity flows through the antenna portions 25A and 25B when the antenna portions 25A and 25B transmit or receive radio waves. Note that the lengths of the antenna portions 25A and 25B may be substantially the same.

The antenna portions 25 are used for wireless communication in a frequency band of 450 M to 3.6 GHz band used in a fourth generation communication system (4G) and a frequency band of 3.6 G to 6 GHz band (sub-6) used in a fifth generation communication system (5G). The frequency bands of the 450 M to 3.6 GHz band and the 3.6 GHz to 6 GHz band are examples of a first frequency band. Note that the antenna portions 25 may be used as antennas that perform wireless communication in any one of a frequency band used in 4G, a frequency band used in 5G, and other frequency bands.

A length of the right end wall 32 and the second wall 36 connected in a substantially L shape is substantially equal to the length of the antenna portion 25B. The electric component 33 electrically connects the first wall 35 and the second wall 36, so that the antenna portion 25A is longer than the antenna portion 25B. Therefore, the antenna portion 25A is used as an antenna that performs wireless communication in a low frequency band among the above frequency bands. The antenna portion 25B is used as an antenna that performs wireless communication in a high frequency band among the above frequency bands. Note that as described above, the antenna portions 25A and 25B may have substantially the same lengths and may be used as antennas that perform wireless communication in substantially the same frequency band.

The metal portion 22 is coated with, for example, an insulating paint. This prevents a conductor in contact with each of the antenna portions 25 from deteriorating antenna characteristics of the antenna portion 25.

The resin portion 23 is made of synthetic resin and has an insulating property. Note that the transmission portion may be made of another material. Radio waves used for communication by the communication device 10 can be transmitted through the resin portion 23. Note that the resin portion 23 may slightly affect the radio waves as long as the radio waves can be transmitted through the resin portion 23.

The resin portion 23 is formed integrally with the metal portion 22 by, for example, insert molding (two-color molding). As a result, the resin portion 23 is fixed to the metal portion 22. Note that the resin portion 23 may be fixed to the metal portion 22 by screwing, snap-fitting, bonding, or another method. As illustrated in FIG. 2, the resin portion 23 includes an upper end wall 51, a right end wall 52, and a left end wall 53.

The upper end wall 51 is located at an upper end portion 11b of the housing 11 and extends in the X direction. That is, the upper end wall 51 extends in parallel (in the same direction) with the lower end wall 31 and the lower end wall 41. The upper end portion 11b is an end portion of the housing 11 in the upper direction. The upper end portion 11b includes an end of the housing 11 facing upward and at least some portions including the end. The upper end portion 11b extends in the X direction. That is, the upper end wall 51 extends in a direction orthogonal to (intersecting with) a direction in which the upper end portion 11b faces.

The right end wall 52 is connected to a right end portion 51a of the upper end wall 51 and extends in the −Y direction. That is, the right end wall 52 extends in a direction orthogonal to (intersecting with) a direction in which the upper end wall 51 extends. The right end portion 51a is an end portion of the upper end wall 51 in the +X direction. The right end wall 52 is connected to the right end wall 32 of the antenna portion 25A. The right end wall 52 and the right end wall 32 of the antenna portion 25A form one wall extending substantially linearly in the Y direction.

The left end wall 53 is connected to a left end portion 51b of the upper end wall 51 and extends in the −Y direction. That is, the left end wall 53 extends in a direction orthogonal to (intersecting with) the direction in which the upper end wall 51 extends. The left end portion 51b is an end portion of the upper end wall 51 in the −X direction. That is, the left end portion 51b is an end portion of the upper end wall 51 on an opposite side of the right end portion 51a. The left end wall 53 is connected to the left end wall 42 of the antenna portion 25B. The left end wall 53 and the left end wall 42 of the antenna portion 25B form one wall extending substantially linearly in the Y direction.

The display device 12 illustrated in FIG. 1 is, for example, a liquid crystal display (LCD). Note that the display device 12 may be another display device such as an organic light electro-luminescence (OLED) display. The display device 12 has a substantially flat screen 12a.

The display device 12 can display an image on the screen 12a. The image includes, for example, a still image, a moving image, an operating system (OS), and a graphical user interface (GUI) of an application.

The screen 12a is a plane that faces the +Z direction and extends in the X direction and the Y direction. That is, the screen 12a faces in a direction orthogonal to (intersecting with) a direction in which each of the lower end wall 31, the right end wall 32, the lower end wall 41, the left end wall 42, the upper end wall 51, the right end wall 52, and the left end wall 53 extends. The lower direction, the upper direction, the right direction, and the left direction are directions along the screen 12a (parallel to the screen 12a). In addition, the X direction is also a short direction of the screen 12a, and the Y direction is also a longitudinal direction of the screen 12a.

When the communication device 10 is activated for the first time, the screen 12a displays an image such that the +Y direction corresponds to the upper direction of the image, the −Y direction corresponds to the lower direction of the image, the +X direction corresponds to the right direction of the image, and the −X direction corresponds to the left direction of the image. In other words, in the screen 12a, a side close to the lower end walls 31 and 41 is a lower side, a side close to the upper end wall 51 is an upper side, a side close to the right end walls 32 and 52 is a right side, and a side close to the left end walls 42 and 53 is a left side. That is, the lower direction, the upper direction, the right direction, and the left direction in the present disclosure are based on FIG. 1, and are also based on an orientation of the image displayed on the screen 12a at the time of initial activation of the communication device 10.

Each of the antenna components 13 illustrated in FIG. 2 is, for example, a module including a plurality of antennas and an electronic component that controls wireless communication using the antennas. Note that the antenna component 13 may include only an antenna, or may further include other components.

The antenna component 13 is used for wireless communication in a frequency band higher than the frequency band used by the antenna portion 25. The antenna component 13 is used for wireless communication in a frequency band of 28 GHz band used in 5G. The frequency band of the 28 GHz band is an example of a second frequency band. Note that the second frequency band is not limited to this example. In general, radio waves in the 28 GHz band have strong rectilinearity (directivity). The antenna component 13 performs communication by, for example, beamforming. Note that the frequency band of the wireless communication of the antenna component 13 may include other frequency bands or may be a frequency band different from the 28 GHz band.

The communication device 10 of the present disclosure includes three antenna components 13. Note that the number of the antenna components 13 mounted on the communication device 10 is not limited to this example. Hereinafter, the antenna components 13 may be individually referred to as antenna components 13A, 13B, and 13C. Note that the description common to the antenna components 13A, 13B, and 13C will be described as the description of the antenna components 13.

The antenna component 13A is located near the upper end wall 51 of the resin portion 23 and extends in the X direction. That is, the antenna component 13A extends in parallel (in the same direction) with the upper end wall 51. In other words, the antenna component 13A is disposed along the upper end portion 11b of the housing 11.

The antenna component 13B is located near the right end wall 52 of the resin portion 23 and extends in the Y direction. That is, the antenna component 13B extends in parallel (in the same direction) with the right end wall 52. In other words, the antenna component 13B is disposed along a right end portion 11c of the housing 11. The right end portion 11c is an end portion of the housing 11 in the +X direction and extends in the Y direction. The right end portion 11c connects the lower end portion 11a and the upper end portion 11b.

The antenna component 13C is located near the left end wall 53 of the resin portion 23 and extends in the Y direction. That is, the antenna component 13C extends in parallel (in the same direction) with the left end wall 53. In other words, the antenna component 13C is disposed along a left end portion 11d of the housing 11. The left end portion 11d is an end portion of the housing 11 in the −X direction and extends in the Y direction. The left end portion 11d is located on an opposite side of the right end portion 11c, and connects the lower end portion 11a and the upper end portion 11b.

The antenna components 13A, 13B, and 13C have portions closer to the upper end portion 11b of the housing 11 than the lower end portion 11a of the housing 11. In the present embodiment, the antenna components 13A, 13B, and 13C are closer to the upper end portion 11b of the housing 11 than the lower end portion 11a of the housing 11. In other words, a distance between the antenna components 13A, 13B, and 13C and the upper end portion 11b of the housing 11 is shorter than a distance between the antenna components 13A, 13B, and 13C and the lower end portion 11a of the housing 11. Note that the antenna components 13A, 13B, and 13C may have portions closer to the lower end portion 11a of the housing 11 than the upper end portion 11b of the housing 11. In addition, each of the antenna components 13 may be closer to the lower end portion 11a of the housing 11 than the upper end portion 11b of the housing 11.

The antenna component 13 is fitted into, for example, a recess provided in the housing 11. The antenna component 13 is covered with the resin portion 23 of the frame 21. Radio waves transmitted by the antenna component 13 or received by the antenna component 13 pass through the resin portion 23. The antenna component 13 is closer to the resin portion 23 than the metal portion 22.

The antenna component 13 is electrically connected to a substrate of the communication device 10 via, for example, wiring such as a flexible printed circuit board (FPC). On the substrate of the communication device 10, for example, a controller capable of controlling wireless communication using the antenna component 13 is mounted.

The ground 14 illustrated in FIG. 3 is, for example, a ground plate or a ground layer of a substrate. Note that the ground 14 is not limited to this example. The ground 14 is electrically connected to the antenna portions 25A and 25B via electric components and wiring.

The communication device 10 further includes a first feeder 61, an antenna tuner 62, a first antenna switch 63, a second antenna switch 64, a second feeder 65, and an electric component 66. The first feeder 61 is an example of a feeder.

The first feeder 61 is connected to an upper end portion 32a of the right end wall 32 of the antenna portion 25A via an electric path Pf1. The upper end portion 32a is an end portion of the right end wall 32 in the +Y direction. That is, the upper end portion 32a is an end portion of the right end wall 32 on an opposite side of the lower end wall 31. The electric path Pf1 is a path through which electricity flows between the first feeder 61 and the antenna portion 25A. The electric path Pf1 is formed of, for example, a conductor such as wiring or a screw. The first feeder 61 applies an alternate current (AC) voltage to the antenna portion 25A. In addition, the first feeder 61 is also connected to the ground 14.

The antenna tuner 62 is provided on the electric path Pf1 between the first feeder 61 and the antenna portion 25A. The antenna tuner 62 includes, for example, a plurality of switches, a plurality of integrated circuits (ICs), and a variable capacitor. Note that elements included in the antenna tuner 62 are not limited to this example. The antenna tuner 62 can change the antenna characteristics of the antenna portion 25A by switching on/off of each switch.

The ground 14 is connected to a left end portion 35b of the first wall 35 of the antenna portion 25A via an electric path Pg1. The electric path Pg1 is an example of a first electric path. The left end portion 35b is an end portion of the first wall 35 in the −X direction. That is, the left end portion 35b is one end portion farther from the second wall 36 than another end portion among the end portions of the first wall 35. Note that the electric path Pg1 may be connected to another portion of the first wall 35.

Furthermore, the ground 14 is connected to a middle portion 35c of the first wall 35 of the antenna portion 25A via an electric path Pg2. The electric path Pg2 is an example of a second electric path. The middle portion 35c is located between the right end portion 35a and the left end portion 35b.

The electric path Pg2 electrically connects the antenna portion 25A and the ground 14 in parallel with the electric path Pg1. As described above, the antenna portion 25A has one feeding point and two ground (GND) points, and can be referred to as a double loop antenna. The antenna portion 25A can be used as a first antenna A1 having a GND point connected to the ground 14 via the electric path Pg1 and a second antenna A2 having a GND point connected to the ground 14 via the electric path Pg2.

The first antenna switch 63 is provided on the electric path Pg1 between the antenna portion 25A and the ground 14. The first antenna switch 63 includes, for example, a plurality of switches and a plurality of ICs. Note that elements included in the first antenna switch 63 are not limited to this example. The first antenna switch 63 can change antenna characteristics of the first antenna A1 of the antenna portion 25A by switching on/off of each switch.

The second antenna switch 64 is provided on the electric path Pg2 between the antenna portion 25A and the ground 14. The second antenna switch 64 includes, for example, a plurality of switches and a plurality of ICs. Note that elements included in the second antenna switch 64 are not limited to this example. The second antenna switch 64 can change antenna characteristics of the second antenna A2 of the antenna portion 25A by switching on/off of each switch.

The second feeder 65 is connected to a right end portion 41b of the lower end wall 41 of the antenna portion 25B via an electric path Pf2. The right end portion 41b is an end portion of the lower end wall 41 in the +X direction. That is, the right end portion 41b is one end portion closer to the first wall 35 than another end portion among the end portions of the lower end wall 41. The right end portion 41b faces the left end portion 35b of the first wall 35. The electric path Pf2 is a path through which electricity flows between the second feeder 65 and the antenna portion 25B. The electric path Pf2 is formed of, for example, a conductor such as wiring or a screw. The second feeder 65 applies an AC voltage to the antenna portion 25B. In addition, the second feeder 65 is also connected to the ground 14.

The ground 14 is connected to an upper end portion 42a of the left end wall 42 of the antenna portion 25B via an electric path Pg3. The upper end portion 42a is an end portion of the left end wall 42 in the +Y direction. That is, the upper end portion 42a is an end portion of the left end wall 42 on an opposite side of the lower end wall 41. Note that the electric path Pg3 may be connected to another portion of the left end wall 42.

The electric component 66 is, for example, a filter, an inductor, or a capacitor. Note that the electric component 66 is not limited to this example. The electric component 66 is provided on the electric path Pg3.

As described above, the antenna tuner 62, the first antenna switch 63, and the second antenna switch 64 change the antenna characteristics of the antenna portion 25A. Changing the antenna characteristics of the antenna portion 25A also affects the antenna characteristics of the antenna portion 25B. Therefore, the antenna characteristics of the antenna portions 25A and 25B can be changed by the antenna tuner 62, the first antenna switch 63, and the second antenna switch 64.

As illustrated in FIG. 2, the communication device 10 such as a smartphone may be used while being held by a hand H of a user. In general, the hand H of the user often holds the right end portion 11c and the left end portion 11d of the housing 11. In this case, the hand H of the user partially covers the lower end portion 11a, the right end portion 11c, and the left end portion 11d of the housing 11. On the other hand, the upper end portion 11b of the housing 11 and portions of the right end portion 11c and the left end portion 11d close to the upper end portion 11b are often exposed without being covered by the hand H of the user. Note that a method of holding the communication device 10 with the hand H of the user is not limited to this example.

In general, radio waves in the 28 GHz band used in 5G have high rectilinearity. Therefore, when the hand H of the user covers the antenna component 13, antenna characteristics of the antenna component 13 using the radio waves in the 28 GHz band may be deteriorated.

On the other hand, radio waves used in 4G and radio waves of sub-6 used in 5G have lower rectilinearity than the radio waves in the 28 GHz band, and are likely to cause wraparound. Therefore, even if the hand H of the user covers the antenna portion 25, the radio waves cause wraparound, so that the antenna characteristics of the antenna portion 25 are hardly deteriorated.

In addition, in general, when an antenna is close to a component such as the display device 12, antenna characteristics of the antenna may be deteriorated. Therefore, by disposing the antenna at a position far from a component such as the display device 12, it is possible to prevent deterioration of the antenna characteristics.

In the communication device 10 of the present disclosure, the antenna component 13 has a portion closer to the upper end portion 11b of the housing 11 that is less likely to be covered by the hand H of the user than the lower end portion 11a of the housing 11 that is often covered by the hand H of the user. Therefore, the antenna component 13 that performs wireless communication in a high frequency band having high rectilinearity is less likely to be covered by the hand H of the user, and the antenna characteristics are less likely to be deteriorated.

On the other hand, the antenna portion 25 may be covered by the hand H of the user. However, the antenna portion 25 that performs wireless communication in a low frequency band where wraparound of radio waves is likely to occur is less likely to deteriorate the antenna characteristics even if the antenna portion 25 is partially covered by the hand H of the user.

In addition, the antenna portion 25 is a part of the frame 21 of the housing 11. Therefore, the antenna portion 25 is disposed at a position farthest or relatively far from the display device 12 in the communication device 10. Therefore, the antenna characteristics of the antenna portion 25 are less likely to be deteriorated as compared with a case where the antenna is disposed at another position.

In the communication device 10 of the first embodiment described above, the housing 11 includes the metal portion 22 and the resin portion 23. The metal portion 22 is used as an antenna that performs wireless communication in a predetermined frequency band. The resin portion 23 is fixed to the metal portion 22 and is capable of transmitting radio waves. The metal portion 22 is located at least at one end portion (the lower end portion 11a) of the housing 11. The antenna component 13 is used for wireless communication in a predetermined frequency band, and is covered with the resin portion 23.

Arrangement and configurations of the metal portion 22 and the antenna component 13 are different from each other, and can be selected according to characteristics of the frequency band in which wireless communication is performed. As a result, the communication device 10 can suppress deterioration of communication performance in wireless communication in a plurality of frequency bands.

The antenna component 13 has a portion closer to the upper end portion 11b of the housing 11 than the lower end portion 11a of the housing 11. That is, the metal portion 22 and the antenna component 13 may be disposed at positions separated from each other, and may be provided with a portion that transmits and receives radio waves at a position suitable for a frequency band in which each of the metal portion 22 and the antenna component 13 performs wireless communication. As a result, the communication device 10 can suppress deterioration of communication performance in wireless communication in a plurality of frequency bands.

The antenna component 13 is used for wireless communication in a predetermined frequency band higher than a frequency band of the metal portion 22. Since the frequency band of the metal portion 22 is lower than the frequency band of the antenna component 13, radio waves in the frequency band of the metal portion 22 have lower rectilinearity than radio waves in the frequency band of the antenna component 13 and easily cause wraparound. Furthermore, in a case where the hand H of the user holds the vicinity of the lower end portion 11a of the housing 11, the antenna component 13 is less likely to be covered by the hand H of the user. As a result, in a case where the communication device 10 is held by the hand H of the user, it is possible to suppress deterioration of communication performance in wireless communication in the frequency band of the metal portion 22 and the frequency band of the antenna component 13.

The frequency band of the metal portion 22 includes at least one of the frequency band used in 5G and the frequency band used in 4G. When the frequency band of the metal portion 22 includes the frequency band used in 4G, the radio waves in the frequency band of the metal portion 22 are more likely to cause wraparound than the radio waves in the frequency band used in 5G. Furthermore, as described above, the frequency band of the metal portion 22 is lower than the frequency band of the antenna component 13. Therefore, even if the frequency band of the metal portion 22 is a frequency band used in 5G, the frequency band of the metal portion 22 is a frequency band (for example, sub-6) in which wraparound is more likely to occur than the frequency band of the antenna component 13. Therefore, in a case where the communication device 10 is held by the hand H of the user, it is possible to suppress deterioration of communication performance in wireless communication in the frequency band of the metal portion 22.

The frequency band of the antenna component 13 is a frequency band used in 5G, and has high rectilinearity. As described above, even when the housing 11 is held by the hand H of the user, the antenna component 13 used for wireless communication in the frequency band is hardly covered by the hand H of the user. As a result, in a case where the communication device 10 is held by the hand H of the user, it is possible to suppress deterioration of communication performance in wireless communication in the frequency band of the antenna component 13.

The antenna portion 25A of the metal portion 22 has the lower end wall 31 and the right end wall 32. The lower end wall 31 is located at the lower end portion 11a of the housing 11 and extends in the X direction (+X direction). The right end wall 32 is connected to the right end portion 31a of the lower end wall 31 and extends in the +Y direction. That is, the antenna portion 25A has the corner portion 21a of the frame 21 of the housing 11. The corner portion 21a of the housing 11 is a portion farthest or relatively far from a component such as the display device 12 in the housing 11. Therefore, deterioration, by a component such as the display device 12, of the antenna characteristics of the antenna portion 25A is suppressed. In addition, this makes it possible to increase an occupancy of the screen 12a of the display device 12 in the communication device 10.

The antenna portion 25B of the metal portion 22 has the lower end wall 41 and the left end wall 42. The lower end wall 41 is located at the lower end portion 11a of the housing 11, extends in the X direction (−X direction), and is separated from the lower end wall 31 of the antenna portion 25A in the −X direction. The left end wall 42 is connected to the left end portion 41a of the lower end wall 41 and extends in the +Y direction. A part of the resin portion 23 is interposed between the lower end wall 31 and the lower end wall 41. Therefore, the communication device 10 can use the antenna portion 25A and the antenna portion 25B as different antennas. For example, the communication device 10 can receive radio waves from a plurality of directions by the antenna portion 25A and the antenna portion 25B. In addition, since the metal portion 22 is divided into the antenna portion 25A and the antenna portion 25B, the lengths of the antenna portions 25A and 25B can be optimized.

The length of the antenna portion 25A is different from the length of the antenna portion 25B. As a result, the communication device 10 can receive radio waves in a plurality of frequency bands by the antenna portion 25A and the antenna portion 25B.

The −Y direction, the +Y direction, the +X direction, and the −X direction are directions along the screen 12a of the display device 12. Therefore, the antenna portion 25A and the antenna portion 25B have the corner portions 21a and 21b of the frame 21 of the housing 11 far from the display device 12, respectively. Therefore, deterioration, by the display device 12, of the antenna characteristics of the antenna portion 25A and the antenna portion 25B is suppressed.

The −Y direction is a lower direction, and the +Y direction is an upper direction. In general, the user often holds left and right end portions of a lower portion of the housing 11. As described above, the metal portion 22 has the lower end walls 31 and 41 located at the lower end portion 11a. The lower end walls 31 and 41 are less likely to be completely covered by the hand H of the user. Furthermore, in a case where the hand H of the user holds the housing 11, the antenna component 13 is less likely to be covered by the hand H of the user as described above. Therefore, in a case where the communication device 10 is held by the hand H of the user, it is possible to suppress deterioration of communication performance in wireless communication in the frequency band of the metal portion 22 and the frequency band of the antenna component 13.

The first antenna switch 63 is provided on the electric path Pg1 between the antenna portion 25A and the ground 14, and changes the antenna characteristics of the antenna portion 25A. As a result, the antenna portion 25A can perform wireless communication at a plurality of frequencies.

The second antenna switch 64 is provided on the electric path Pg2 that electrically connects the antenna portion 25A and the ground 14 in parallel with the electric path Pg1, and changes the antenna characteristics of the antenna portion 25A. That is, the antenna portion 25A is a double ground loop antenna connected to the ground 14 via the two parallel electric paths Pg1 and Pg2. Therefore, in the antenna portion 25A, for example, a change in an electric field generated by the hand H of the user is small as compared with other types of antennas such as a monopole antenna. Therefore, in a case where the communication device 10 is held by the hand H of the user, it is possible to suppress deterioration of communication performance in wireless communication in the frequency band of the metal portion 22.

The lower end wall 31 includes the first wall 35 extending in the +X direction and the second wall 36 separated from the first wall 35 in the +X direction and extending in the +X direction. A portion of the resin portion 23 is interposed between the first wall 35 and the second wall 36. The antenna portion 25A has the electric component 33 that electrically connects the first wall 35 and the second wall 36. As a result, the slit S2 is provided between the lower end wall 31 and the lower end wall 41, and the slit S1 is also provided between the first wall 35 and the second wall 36, so that an appearance of the communication device 10 can have symmetry.

### Second Embodiment

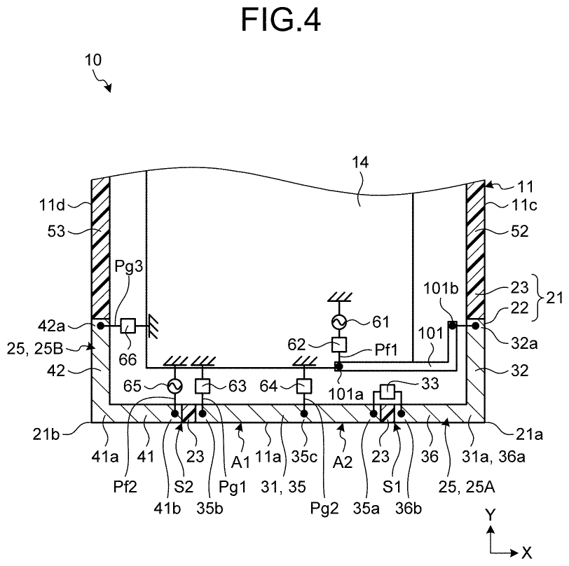

FIG. 4 is a front view partially and schematically illustrating a part of an internal configuration of a communication device 10 of a second embodiment. As illustrated in FIG. 4, the communication device 10 according to the second embodiment further includes a laser direct structure (LDS) antenna 101.

The LDS antenna 101 is provided on the electric path Pf1 between the antenna portion 25A and the first feeder 61. For example, the LDS antenna 101 is provided on a surface of the housing 11 or another member.

One end portion 101a of the LDS antenna 101 is connected to the antenna tuner 62 via a conductor of the electric path Pf1 such as wiring or a screw. Another end portion 101b of the LDS antenna 101 is connected to the upper end portion 32a of the right end wall 32 of the antenna portion 25A via the conductor of the electric path Pf1. That is, the LDS antenna 101 is interposed between the antenna tuner 62 and the antenna portion 25A on the electric path Pf1.

In the communication device 10 of the second embodiment described above, the LDS antenna 101 is provided on the electric path Pf1 between the antenna portion 25A and the first feeder 61. The LDS antenna 101 has a high degree of freedom in design. Therefore, the length and the antenna characteristics of the antenna portion 25A can be optimized as an antenna.

### Third Embodiment

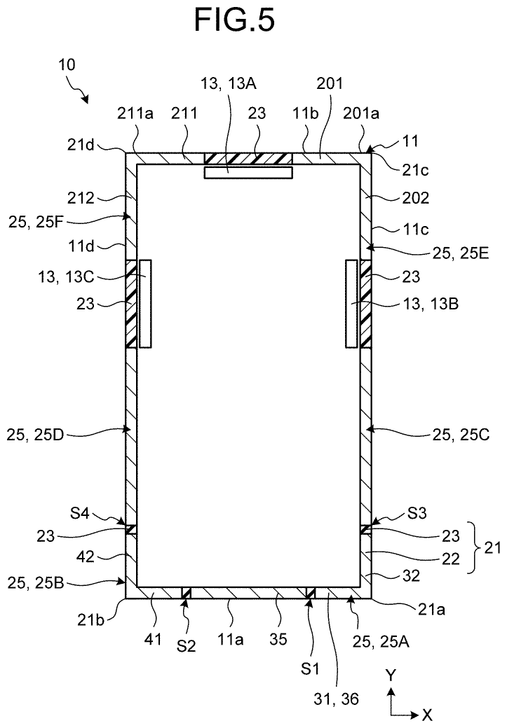

FIG. 5 is a front view schematically illustrating a part of an internal configuration of a communication device 10 according to a third embodiment. As illustrated in FIG. 5, the metal portion 22 of the third embodiment includes four antenna portions 25C, 25D, 25E, and 25F in addition to the two antenna portions 25A and 25B.

The antenna portion 25C is located at the right end portion 11c of the housing 11 and extends in the Y direction. That is, the antenna portion 25C extends in a direction orthogonal to the direction in which the lower end wall 31 extends. The antenna portion 25C is separated from the right end wall 32 of the antenna portion 25A in the +Y direction. That is, the antenna portion 25C is separated from the right end wall 32 in a direction in which the right end wall 32 extends. Therefore, a slit S3 is provided between the antenna portion 25C and the right end wall 32. The slit S3 between the antenna portion 25C and the right end wall 32 is filled with the resin portion 23. That is, a part of the resin portion 23 is interposed between the antenna portion 25C and the right end wall 32.

The antenna portion 25D is located at the left end portion 11d of the housing 11 and extends in the Y direction. That is, the antenna portion 25D extends in a direction orthogonal to the direction in which the lower end wall 31 extends. The antenna portion 25D is separated from the left end wall 42 of the antenna portion 25B in the +Y direction. That is, the antenna portion 25D is separated from the left end wall 42 in a direction in which the left end wall 42 extends. Therefore, a slit S4 is provided between the antenna portion 25D and the left end wall 42. The slit S4 between the antenna portion 25D and the left end wall 42 is filled with the resin portion 23. That is, a part of the resin portion 23 is interposed between the antenna portion 25D and the left end wall 42.

The antenna portion 25E has an upper end wall 201 and a right end wall 202. The upper end wall 201 is located at the upper end portion 11b of the housing 11 and extends in the X direction. That is, the upper end wall 201 extends in parallel (in the same direction) with the lower end wall 31. The right end wall 202 is connected to a right end portion 201a of the upper end wall 201 and extends in the −Y direction. That is, the right end wall 202 extends in a direction orthogonal to (intersecting with) a direction in which the upper end wall 201 extends. The right end wall 202 extends from the right end portion 201a toward the antenna portion 25C. The right end portion 201a is an end portion of the upper end wall 201 in the +X direction. As described above, the antenna portion 25E is formed in a substantially L shape. The antenna portion 25E forms a corner portion 21c of the frame 21. The corner portion 21c is a portion where the upper end wall 201 and the right end wall 202 are connected.

The antenna portion 25F has an upper end wall 211 and a left end wall 212. The upper end wall 211 is located at the upper end portion 11b of the housing 11 and extends in the X direction. That is, the upper end wall 211 extends in parallel (in the same direction) with the lower end wall 31. The left end wall 212 is connected to a left end portion 211a of the upper end wall 211 and extends in the −Y direction. That is, the left end wall 212 extends in a direction orthogonal to (intersecting with) a direction in which the upper end wall 211 extends. The left end wall 212 extends from the left end portion 211a toward the antenna portion 25D. The left end portion 211a is an end portion of the upper end wall 211 in the −X direction. As described above, the antenna portion 25F is formed in a substantially L shape. The antenna portion 25F forms a corner portion 21d of the frame 21. The corner portion 21d is a portion where the upper end wall 211 and the left end wall 212 are connected.

The upper end wall 211 of the antenna portion 25F is separated in the −X direction from the upper end wall 201 of the antenna portion 25E. That is, the upper end wall 211 is separated from the upper end wall 201 in the direction in which the upper end wall 211 or the upper end wall 201 extends. The portion between the upper end wall 201 and the upper end wall 211 is filled with the resin portion 23. That is, a part of the resin portion 23 is interposed between the upper end wall 201 and the upper end wall 211.

In the X direction in which the upper end wall 211 and the upper end wall 201 extend, a distance between the upper end wall 201 of the antenna portion 25E and the upper end wall 211 of the antenna portion 25F is substantially equal to a length of the antenna component 13A. Note that the distance between the upper end wall 201 and the upper end wall 211 may be longer than the length of the antenna component 13A or may be shorter than the length of the antenna component 13A.

The resin portion 23 between the upper end wall 201 and the upper end wall 211 covers the antenna component 13A. Radio waves transmitted by the antenna component 13A or received by the antenna component 13A pass through the resin portion 23 between the upper end wall 201 and the upper end wall 211.

The right end wall 202 of the antenna portion 25E is separated from the antenna portion 25C in the +Y direction. That is, the right end wall 202 is separated from the antenna portion 25C in a direction in which the right end wall 202 or the antenna portion 25C extends. The portion between the right end wall 202 and the antenna portion 25C is filled with the resin portion 23. That is, a part of the resin portion 23 is interposed between the right end wall 202 and the antenna portion 25C.

In the Y direction in which the right end wall 202 and the antenna portion 25C extend, a distance between the right end wall 202 of the antenna portion 25E and the antenna portion 25C is substantially equal to a length of the antenna component 13B. Note that the distance between the right end wall 202 and the antenna portion 25C may be longer than the length of the antenna component 13B or shorter than the length of the antenna component 13B.

The resin portion 23 between the right end wall 202 and the antenna portion 25C covers the antenna component 13B. Radio waves transmitted by the antenna component 13B or received by the antenna component 13B pass through the resin portion 23 between the right end wall 202 and the antenna portion 25C.

The left end wall 212 of the antenna portion 25F is separated from the antenna portion 25D in the +Y direction. That is, the left end wall 212 is separated from the antenna portion 25D in a direction in which the left end wall 212 or the antenna portion 25D extends. The portion between the left end wall 212 and the antenna portion 25D is filled with the resin portion 23. That is, a part of the resin portion 23 is interposed between the left end wall 212 and the antenna portion 25D.

In the Y direction in which the left end wall 212 and the antenna portion 25D extend, a distance between the left end wall 212 of the antenna portion 25F and the antenna portion 25D is substantially equal to the length of the antenna component 13C. Note that the distance between the left end wall 212 and the antenna portion 25D may be longer than the length of the antenna component 13C or shorter than the length of the antenna component 13C.

The resin portion 23 between the left end wall 212 and the antenna portion 25D covers the antenna component 13C. Radio waves transmitted by the antenna component 13C or received by the antenna component 13C pass through the resin portion 23 between the left end wall 212 and the antenna portion 25D.

In the communication device 10 of the third embodiment described above, the metal portion 22 includes the antenna portions 25C, 25D, 25E, and 25F located at the right end portion 11c, the left end portion 11d, and the upper end portion 11b of the housing 11. Therefore, the communication device 10 can receive radio waves from a plurality of directions by the antenna portions 25C, 25D, 25E, and 25F.

The antenna component 13 is covered with the resin portion 23 interposed between the antenna portions 25C, 25D, 25E, and 25F. As a result, the antenna component 13 can perform wireless communication by radio waves transmitted through the resin portion 23.

### Fourth Embodiment

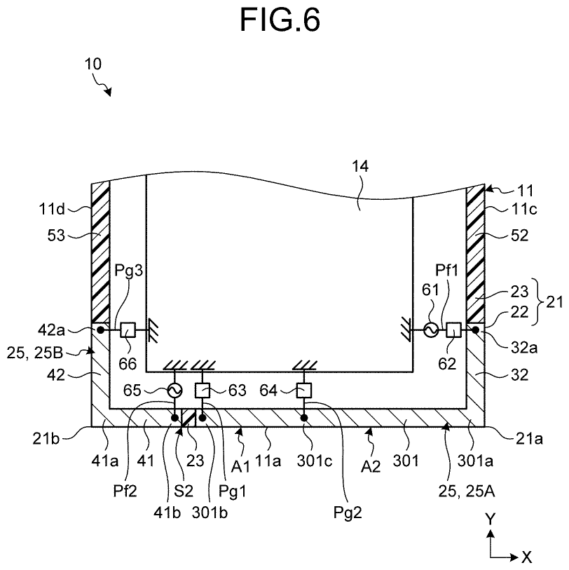

FIG. 6 is a front view partially and schematically illustrating a part of an internal configuration of a communication device 10 of a fourth embodiment. As illustrated in FIG. 6, the antenna portion 25A of the fourth embodiment has a lower end wall 301 instead of the lower end wall 31 of the first to third embodiments. The lower end wall 301 is also an example of the first end wall.

The lower end wall 301 is located at the lower end portion 11a of the housing 11 and extends in the X direction (+X direction). That is, the lower end wall 301 extends in a direction orthogonal to (intersecting with) the direction in which the lower end portion 11a faces. The right end wall 32 is connected to a right end portion 301a of the lower end wall 301 and extends in the +Y direction. That is, the right end wall 32 extends in a direction orthogonal to (intersecting with) the direction in which the lower end wall 301 extends. The right end portion 301a is an end portion of the lower end wall 301 in the +X direction. In the fourth embodiment, the corner portion 21a of the frame 21 is a portion where the lower end wall 301 and the right end wall 32 are connected.

The lower end wall 41 of the antenna portion 25B is separated from the lower end wall 301 of the antenna portion 25A in the −X direction. That is, the lower end wall 41 is separated from the lower end wall 301 on an opposite side of the right end wall 32. The resin portion 23 is interposed between the lower end wall 301 of the antenna portion 25A and the lower end wall 41 of the antenna portion 25B.

The ground 14 is connected to a left end portion 301b of the lower end wall 301 of the antenna portion 25A via the electric path Pg1. The left end portion 301b is an end portion of the lower end wall 301 in the −X direction. That is, the left end portion 301b is one end portion closer to the lower end wall 41 than another end portion among the end portions of the lower end wall 301. Note that the electric path Pg1 may be connected to another portion of the lower end wall 301.

Furthermore, the ground 14 is connected to a middle portion 301c of the lower end wall 301 of the antenna portion 25A via the electric path Pg2. The middle portion 301c is located between the right end portion 301a and the left end portion 301b.

In the communication device 10 of the fourth embodiment described above, the lower end wall 301 is not divided as the lower end wall 31 of the first to third embodiments. The lower end wall 301 is continuous between the right end portion 301a connected to the right end wall 32 and the left end portion 301b connected to the ground 14 via the electric path Pg1. As a result, the electric component 33 is omitted, the number of components is reduced, and the cost of the communication device 10 is reduced.

### Fifth Embodiment

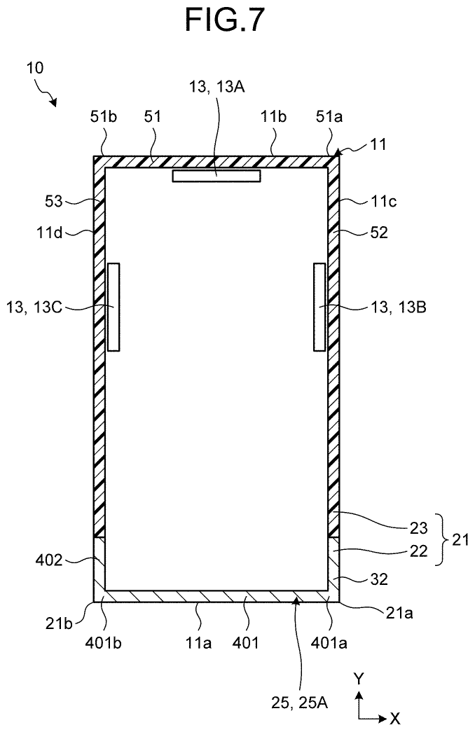

FIG. 7 is a front view schematically illustrating a part of an internal configuration of a communication device 10 according to a fifth embodiment. As illustrated in FIG. 7, the metal portion 22 of the fifth embodiment has one antenna portion 25A. The antenna portion 25A has a lower end wall 401 and a left end wall 402 instead of the lower end wall 31 of the first to third embodiments. The lower end wall 401 is also an example of the first end wall.

The lower end wall 401 is located at the lower end portion 11a of the housing 11 and extends in the X direction (+X direction). The right end wall 32 is connected to a right end portion 401a of the lower end wall 401 and extends in the +Y direction. That is, the right end wall 32 extends in a direction orthogonal to (intersecting with) a direction in which the lower end wall 401 extends. The right end portion 401a is an end portion of the lower end wall 401 in the +X direction. In the fifth embodiment, the corner portion 21a of the frame 21 is a portion where the lower end wall 401 and the right end wall 32 are connected.

The left end wall 402 is connected to a left end portion 401b of the lower end wall 401 and extends in the +Y direction. That is, the left end wall 402 extends in a direction orthogonal to (intersecting with) the direction in which the lower end wall 401 extends. The left end portion 401b is an end portion of the lower end wall 401 in the −X direction. That is, the left end portion 401b is an end portion on an opposite side of the right end portion 401a. In the fifth embodiment, the corner portion 21b of the frame 21 is a portion where the lower end wall 401 and the left end wall 402 are connected.

In the communication device 10 of the fifth embodiment described above, the metal portion 22 has one antenna portion 25A. As a result, the electric component 33 is omitted, the number of components is reduced, and the cost of the communication device 10 is reduced.

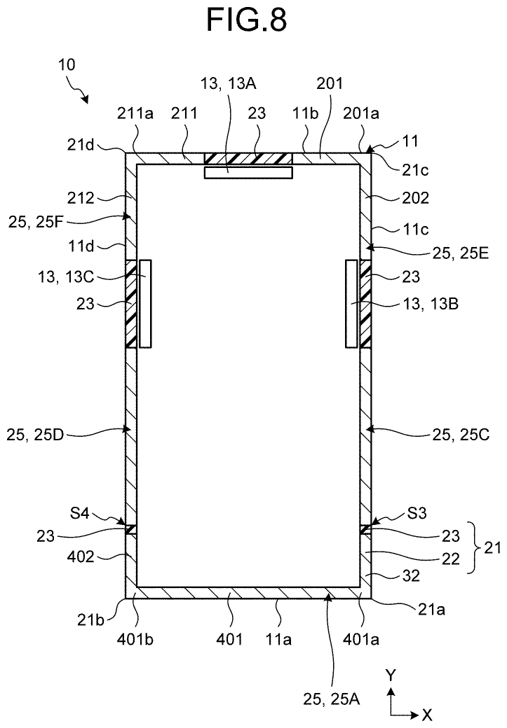

FIG. 8 is a front view schematically illustrating a part of an internal configuration of a communication device 10 according to a modification of the fifth embodiment. In the modification of FIG. 8, the antenna portion 25A has the lower end wall 401 and the left end wall 402. On the other hand, in the modification of FIG. 8, the metal portion 22 further includes the same antenna portions 25C, 25D, 25E, and 25F as those of the third embodiment. As a result, the communication device 10 can receive radio waves from a plurality of directions by the antenna portions 25C, 25D, 25E, and 25F.

(Effects)

A communication device includes a housing and at least one antenna component. The housing includes at least one metal portion used as an antenna that performs wireless communication in a first frequency band, and a transmission portion fixed to the metal portion and capable of transmitting radio waves. The metal portion is located at least at an end portion of the housing in a first direction. The antenna component is used for wireless communication in a second frequency band and is covered by the transmission portion.

Arrangement and configurations of the metal portion and the antenna component are different from each other, and can be selected according to characteristics of a frequency band in which wireless communication is performed. As a result, the communication device can suppress deterioration of communication performance in wireless communication in a plurality of frequency bands.

Furthermore, in the communication device, an antenna portion has a portion closer to an end portion of the housing in a second direction opposite to the first direction than an end portion of the housing in the first direction.

The metal portion and the antenna portion may be disposed at positions separated from each other, and a portion that transmits and receives radio waves may be provided at a position suitable for a frequency band in which each portion performs wireless communication. As a result, the communication device can suppress deterioration of communication performance in wireless communication in a plurality of frequency bands.

In addition, in the communication device, the second frequency band is higher than the first frequency band.

Since the first frequency band is lower than the second frequency band, radio waves in the first frequency band have lower rectilinearity than radio waves in the second frequency band and easily causes wraparound. As a result, for example, in a case where the vicinity of the end portion of the housing in the first direction is held by a hand of a user, the communication device can suppress deterioration of communication performance in wireless communication in the first frequency band.

Furthermore, in the communication device, the first frequency band includes at least one of a frequency band used in a fifth generation mobile communication system and a frequency band used in a fourth generation mobile communication system.

When the first frequency band includes the frequency band used in 4G, radio waves in the first frequency band are more likely to cause wraparound than radio waves in the frequency band used in 5G. In addition, in a case where the first frequency band is lower than the second frequency band, even if the first frequency band is a frequency band used in 5G, the first frequency band is a frequency band (for example, sub-6) in which wraparound is more likely to occur than the second frequency band. Therefore, for example, in a case where the communication device is held by the hand of the user, it is possible to suppress deterioration of the communication performance in the wireless communication in the first frequency band.

Furthermore, in the communication device, the second frequency band includes a frequency band used in the fifth generation mobile communication system.

The frequency band used in 5G has high rectilinearity. The antenna component used for wireless communication in the second frequency band can be disposed at a position that is not easily covered by the hand of the user even when the housing is held by the hand of the user. As a result, for example, in a case where the communication device is held by the hand of the user, it is possible to suppress deterioration of the communication performance in the wireless communication in the second frequency band.

Furthermore, in the communication device, the metal portion includes a first antenna portion used as an antenna that performs wireless communication in the first frequency band. The first antenna portion has a first end wall located at an end portion of the housing in a first direction and extending in a third direction intersecting with the first direction, and a second end wall connected to an end portion of the first end wall in the third direction and extending in a fourth direction (second direction) opposite to the first direction.

As a result, the first antenna portion has a corner portion of the housing. In the housing, the corner portion of the housing is a portion farthest or relatively far from a component accommodated in the housing. Therefore, deterioration, by the component accommodated in the housing, of antenna characteristics of the first antenna portion is suppressed.

Furthermore, in the communication device, the metal portion is used as an antenna that performs wireless communication in the first frequency band, and includes a second antenna portion separated from the first antenna portion. The second antenna portion has a third end wall located at an end portion of the housing in the first direction, extending in a fifth direction opposite to the third direction, and separated from the first end wall in the fifth direction, and a fourth end wall connected to an end portion of the third end wall in the fifth direction, and extending in the fourth direction. A part of the transmission portion is interposed between the first end wall and the third end wall.

As a result, for example, the communication device can receive radio waves from a plurality of directions by the first antenna portion and the second antenna portion. In addition, since the metal portion is divided into the first antenna portion and the second antenna portion, lengths of the first antenna portion and the second antenna portion can be optimized.

Furthermore, in the communication device, the length of the first antenna portion is different from the length of the second antenna portion.

As a result, the communication device can receive radio waves in a plurality of frequency bands by the first antenna portion and the second antenna portion.

Furthermore, the communication device further includes a display device that has a screen, is capable of displaying an image on the screen, and is accommodated in the housing. The first direction, the second direction, the third direction, the fourth direction, and the fifth direction are directions along the screen.

As a result, the first antenna portion and the second antenna portion each have a corner portion of the housing that is far from the display device. Therefore, deterioration, by the display device, of the antenna characteristics of the first antenna portion and the second antenna portion is suppressed.

In addition, in the communication device, the first direction is a lower direction. The fourth direction (the second direction) is an upper direction.

In general, the user often holds left and right end portions of a lower portion of the housing. As described above, the metal portion has the first end wall and the third end wall located at an end portion of the housing in the first direction. The first end wall and the third end wall are less likely to be completely covered by the hand of the user. Furthermore, in a case where the hand of the user holds the housing, the antenna component is less likely to be covered by the hand of the user as described above. Therefore, in a case where the communication device is held by the hand of the user, for example, it is possible to suppress deterioration of the communication performance in wireless communication in the first frequency band and the second frequency band.

Furthermore, the communication device further includes a ground and a first antenna switch. The ground is accommodated in the housing and electrically connected to the first antenna portion. The first antenna switch is provided on a first electric path between the first antenna portion and the ground, and changes the antenna characteristics of the first antenna portion.

As a result, the first antenna portion can perform wireless communication at a plurality of frequencies.

In addition, the communication device further includes a second antenna switch that is provided on a second electric path electrically connecting the first antenna portion and the ground in parallel with the first electric path and changes the antenna characteristics of the first antenna portion.

That is, the first antenna portion is a double ground loop antenna connected to the ground via the parallel first and second electric paths. Therefore, in the first antenna portion, a change in an electric field generated by the hand of the user is small as compared with other types of antennas such as a monopole antenna. Therefore, for example, in a case where the communication device is held by the hand of the user, it is possible to suppress deterioration of the communication performance in the wireless communication in the first frequency band.

Furthermore, the communication device further includes an LDS antenna provided on an electric path between the first antenna portion and a feeder.

The LDS antenna has a high degree of freedom in design. Therefore, the antenna length and the antenna characteristics of the first antenna portion can be optimized.

Furthermore, in the communication device, the first end wall includes a first wall extending in the third direction, and a second wall separated from the first wall in the third direction and extending in the third direction. The second end wall is connected to an end portion of the second wall in the third direction and extends in the fourth direction. A part of the transmission portion is interposed between the first wall and the second wall. The first antenna portion has an electric component that electrically connects the first wall and the second wall.

As a result, a gap is provided between the first end wall and the third end wall, and a gap is also provided between the first wall and the second wall, so that an appearance of the communication device can have symmetry.

As described above, according to an embodiment of the present disclosure, the communication device 10 includes the housing 11 and the antenna component 13. The housing 11 includes the metal portion 22 used as an antenna that performs wireless communication in the first frequency band, and the resin portion 23 fixed to the metal portion 22 and capable of transmitting radio waves. The metal portion 22 is located at least at the lower end portion 11a which is an end portion of the housing 11 in the −Y direction. The antenna component 13 is used for wireless communication in the second frequency band and covered with the resin portion 23. As a result, the communication device 10 can suppress deterioration of the communication performance in wireless communication in the first frequency band and the second frequency band.

Although the embodiments of the present disclosure have been described above, the technical scope of the present disclosure is not limited to the above-described embodiments as it is, and various modifications can be made without departing from the gist of the present disclosure. In addition, constituent elements in different embodiments and modifications may be appropriately combined.

Note that the effects described in the present specification are merely examples and are not limited, and other effects may be provided.

Note that the present technique can also have the following configurations.
(1)
A communication device comprising:

a housing including at least one metal portion that is used as an antenna that performs wireless communication in a first frequency band, and a transmission portion fixed to the metal portion and capable of transmitting a radio wave, the metal portion being located at least at an end portion in a first direction; and

at least one antenna component that is used for wireless communication in a second frequency band and is covered with the transmission portion.
(2)

The communication device according to (1), wherein the antenna component has a portion closer to an end portion of the housing in a second direction opposite to the first direction than an end portion of the housing in the first direction.
(3)

The communication device according to (1) or (2), wherein the second frequency band is higher than the first frequency band.
(4)

The communication device according to any one of (1) to (3), wherein the first frequency band includes at least one of a frequency band used in a fifth generation mobile communication system and a frequency band used in a fourth generation mobile communication system.
(5)

The communication device according to any one of (1) to (4), wherein the second frequency band includes a frequency band used in a fifth generation mobile communication system.
(6)

The communication device according to any one of (1) to (5), wherein

the metal portion includes a first antenna portion used as an antenna that performs wireless communication in the first frequency band, and

the first antenna portion includes a first end wall located at an end portion of the housing in the first direction and extending in a third direction intersecting with the first direction, and a second end wall connected to an end portion of the first end wall in the third direction and extending in a fourth direction (the second direction) opposite to the first direction.
(7)

The communication device according to (6), wherein

the metal portion includes a second antenna portion that is used as an antenna that performs wireless communication in the first frequency band and is separated from the first antenna portion,

the second antenna portion includes a third end wall located at an end portion of the housing in the first direction, extending in a fifth direction opposite to the third direction, and separated from the first end wall in the fifth direction, and a fourth end wall connected to an end portion of the third end wall in the fifth direction, and extending in the fourth direction, and

a part of the transmission portion is interposed between the first end wall and the third end wall.
(8)

The communication device according to (7), wherein a length of the first antenna portion and a length of the second antenna portion are different.
(9)

The communication device according to (7) or (8), further comprising

a display device that includes a screen, is capable of displaying an image on the screen, and is accommodated in the housing, wherein

the first direction, the second direction, the third direction, the fourth direction, and the fifth direction are directions along the screen.
(10)

The communication device according to (9), wherein

the first direction is a lower direction, and

the fourth direction (the second direction) is an upper direction.
(11)

The communication device according to any one of (6) to (10), further comprising:

a ground that is accommodated in the housing and electrically connected to the first antenna portion; and

a first antenna switch that is provided on a first electric path between the first antenna portion and the ground, and changes an antenna characteristic of the first antenna portion.
(12)

The communication device according to (11), further comprising

a second antenna switch that is provided on a second electric path electrically connecting the first antenna portion and the ground in parallel with the first electric path, and changes an antenna characteristic of the first antenna portion.
(13)

The communication device according to any one of (6) to (12), further comprising

a laser direct structure (LDS) antenna provided on an electric path between the first antenna portion and a feeder.
(14)

The communication device according to any one of (7) to (10), wherein

the first end wall includes a first wall extending in the third direction and a second wall separated from the first wall in the third direction and extending in the third direction,

the second end wall is connected to an end portion of the second wall in the third direction and extends in the fourth direction,

a part of the transmission portion is interposed between the first wall and the second wall, and

the first antenna portion includes an electric component that electrically connects the first wall and the second wall.
(15)

The communication device according to any one of (1) to (3), in which the first frequency band includes a frequency lower than 6 GHz.
(16)

The communication device according to any one of (1) to (3) and (15), in which the second frequency band includes 28 GHz.

### REFERENCE SIGNS LIST

10 COMMUNICATION DEVICE

11 HOUSING

11a LOWER END PORTION

12 DISPLAY DEVICE

12a SCREEN

13 ANTENNA COMPONENT

14 GROUND

22 METAL PORTION

23 RESIN PORTION

25 ANTENNA PORTION

25A ANTENNA PORTION

25B ANTENNA PORTION

31 LOWER END WALL

32 RIGHT END WALL

33 ELECTRIC COMPONENT

35 FIRST WALL

36 SECOND WALL

41 LOWER END WALL

42 LEFT END WALL

61 FIRST FEEDER

63 FIRST ANTENNA SWITCH

64 SECOND ANTENNA SWITCH

101 LDS ANTENNA

301 LOWER END WALL

401 LOWER END WALL

Pf1 ELECTRIC PATH

Pg1 ELECTRIC PATH

Pg2 ELECTRIC PATH

1. A communication device comprising:
a housing including at least one metal portion that is used as an antenna that performs wireless communication in a first frequency band, and a transmission portion fixed to the metal portion and capable of transmitting a radio wave, the metal portion being located at least at an end portion in a first direction; and
at least one antenna component that is used for wireless communication in a second frequency band and is covered with the transmission portion.

2. The communication device according to claim 1, wherein the antenna component has a portion closer to an end portion of the housing in a second direction opposite to the first direction than an end portion of the housing in the first direction.

3. The communication device according to claim 1, wherein the second frequency band is higher than the first frequency band.

4. The communication device according to claim 1, wherein the first frequency band includes at least one of a frequency band used in a fifth generation mobile communication system and a frequency band used in a fourth generation mobile communication system.

5. The communication device according to claim 1, wherein the second frequency band includes a frequency band used in a fifth generation mobile communication system.

6. The communication device according to claim 1, wherein
the metal portion includes a first antenna portion used as an antenna that performs wireless communication in the first frequency band, and
the first antenna portion includes a first end wall located at an end portion of the housing in the first direction and extending in a third direction intersecting with the first direction, and a second end wall connected to an end portion of the first end wall in the third direction and extending in a fourth direction opposite to the first direction.

7. The communication device according to claim 6, wherein
the metal portion includes a second antenna portion that is used as an antenna that performs wireless communication in the first frequency band and is separated from the first antenna portion,
the second antenna portion includes a third end wall located at an end portion of the housing in the first direction, extending in a fifth direction opposite to the third direction, and separated from the first end wall in the fifth direction, and a fourth end wall connected to an end portion of the third end wall in the fifth direction, and extending in the fourth direction, and
a part of the transmission portion is interposed between the first end wall and the third end wall.

8. The communication device according to claim 7, wherein a length of the first antenna portion and a length of the second antenna portion are different.

9. The communication device according to claim 7, further comprising
a display device that includes a screen, is capable of displaying an image on the screen, and is accommodated in the housing, wherein
the first direction, the third direction, the fourth direction, and the fifth direction are directions along the screen.

10. The communication device according to claim 9, wherein
the first direction is a lower direction, and
the fourth direction is an upper direction.

11. The communication device according to claim 6, further comprising:
a ground that is accommodated in the housing and electrically connected to the first antenna portion; and
a first antenna switch that is provided on a first electric path between the first antenna portion and the ground, and changes an antenna characteristic of the first antenna portion.

12. The communication device according to claim 11, further comprising
a second antenna switch that is provided on a second electric path electrically connecting the first antenna portion and the ground in parallel with the first electric path, and changes an antenna characteristic of the first antenna portion.

13. The communication device according to claim 6, further comprising
a laser direct structure (LDS) antenna provided on an electric path between the first antenna portion and a feeder.

14. The communication device according to claim 7, wherein
the first end wall includes a first wall extending in the third direction and a second wall separated from the first wall in the third direction and extending in the third direction,
the second end wall is connected to an end portion of the second wall in the third direction and extends in the fourth direction,
a part of the transmission portion is interposed between the first wall and the second wall, and
the first antenna portion includes an electric component that electrically connects the first wall and the second wall.
